(19) United States
(12) Patent Application Publication
(10) Pub. No.: US 2008/0287613 A1
(43) Pub. Date: Nov. 20, 2008

(54) Low-Monomer-Concentration, Low-Viscosity Solutions of Tdi Isocyanurates in Branched Dialkyl Phthalates

(76) Inventors: Joachim Simon, Dusseldorf (DE); Martin Brahm, Odenthal (DE); Thomas Augustin, Koln (DE); Eberhard Kuckert, Leverkusen (DE)

Correspondence Address: Nicanor A. Kohncke;LANXESS Law & Intellectual Property Department, 111 RIDC Park West Drive, Pittsburgh, PA, 15275-1112, US

(21) Appl. No.: 10/586,596

(22) PCT Filed: Jan. 21, 2005
(86) PCT No.: PCT/EP05/00577

§ 371 Date: Aug. 6, 2008

(51) Int. Cl. C08F 283/04

(52) U.S. Cl. 525/454

(57) ABSTRACT

The present invention relates to novel low-monomer-concentration, low-viscosity solutions of diisocyanatotoluene-based isocyanatoisocyanurates in branched dialkyl phthalates as environmentally acceptable plasticizers for polyvinyl chloride, to a process for preparation of these solutions, and to their use as adhesion-promoting additives for coating compositions based on plasticized polyvinyl chloride.

The present invention relates to novel low-monomer-concentration, low-viscosity solutions of diisocyanatotoluene-based isocyanatoisocyanurates in branched dialkyl phthalates as environmentally acceptable plasticizers for polyvinyl chloride, to a process for preparation of these solutions, and to their use as adhesion-promoting additives for coating compositions based on plasticized polyvinyl chloride.

When plasticized PVC or PVC plastisols are used to coat substrates, it is preferable to utilize isocyanate-functional adhesion promoters based on diisocyanatotoluene (in which connection see: “Beschichten mit Kunststoffen” [Coating with Plastics], Carl Hanser Verlag, Munich, 1967 and Kunststoffe 68 (1978), pp. 735 ff, pp. 800 ff), which provide the adhesion to the substrate by way of the reaction and crosslinking of the isocyanate groups.

The homogeneity of the plastisol-polyisocyanate mixture is decisive for ideal coating results. Because polyisocyanates generally have very high viscosity or indeed are solid, it is usual to use solvents to improve processability, these preferably at the same time acting as plasticizers in the PVC-based coating in which they can also therefore remain present (H. Kittel, “Lehrbuch der Lacke und Beschichtungen” [Textbook of Paints and Coatings] 2nd Edn. 1998, Hirzel Verlag Stuttgart, pp. 342 ff. “Polyvinylverbindungen” [Polyvinyl compounds]).

Examples of known plasticizers for PVC coatings are phthalates, adipates, phosphorates, sebacates, azelates, or modified oils. Polyesters, too, are described as plasticizers (“Plasticizers”, Kulkarni, K. B. in Popular Plastics (1966), 11(6), 71-2).

The adhesion promoters here require not only good adhesion properties but also good processability, i.e. low viscosity (<20000 mPas at 23° C.), low content of free diisocyanatotoluene (TDI) (≦0.2% of free TDI), and solvents which do not have to be labelled “toxic”. Good adhesion properties are usually obtained when the adhesion promoters comprise >25% by weight of solid. The existing prior art has not hitherto described a combination of all of these product properties.

DE-A 24 19016 describes polyisocyanates dissolved in plasticizers for PVC, such as high-boiling esters inter alia of phthalic acid having from 7 to 9 carbon atoms in the alcohol radical. Tertiary amines are also mentioned inter alia in non-specific lists as catalysts for the isocyanurate-formation reaction. However, these systems do not achieve the required combination of the product properties described above: viscosity, residual monomer content and solids content.

U.S. Pat. No. 4,115,373 describes the trimerization of isocyanates such as, inter alia, tolylene diisocyanate, in inert solvents of a broad range of boiling point, using Mannich bases as catalysts. The resultant polyisocyanates here have ≦0.7% by weight of free monomer. Low-molecular-weight phthalates, such as dibutyl phthalate and butyl benzyl phthalate, are also mentioned, inter alia, as solvents in non-specific lists. There is no disclosure of the preparation of tolylene-diisocyanate-based isocyanurates in PVC plasticizers with the property combination described at the outset.

DE-A 30 41 732 describes polyisocyanates whose structure is based on 4,4′-diisocyanato-diphenylmethane and on TDI. In Comparative Example 17, polyisocyanates based on TDI mixtures with isomer contents of about 35% by weight of 2,6-diisocyanatotoluene are also used. However, the resultant products do not comply with the required product properties with regard to solids content, viscosity and residual monomer content of TDI.

Patent Application DE 10 229 780 describes a process for preparation of TDI-based polyisocyanates with residual monomer contents <0.2% by weight. However, there is no disclosure of the preparation of solutions comprising plasticizer and having the required low viscosities and mechanical properties.

It was therefore an object of the present invention to provide novel adhesion promoters for PVC plastisols which have acceptable environmental toxicology (no “toxic” label), and are based on industrially available inexpensive plasticizers, and lead to good mechanical properties, e.g. peel strengths. Consequently, the solids contents of these adhesion promoters, based on the polyisocyanate present, must be >25% by weight, the viscosity must be <20000 mPas/23° C., and the content of free TDI monomer, based on all of the isomers, must be ≦0.2% by weight. Furthermore, the plasticizers used as solvent cannot be any of those which have to be labelled “toxic”. The polyisocyanate is also intended to be based on the 2,4- and 2,6-diisocyanatotoluene isomer mixtures available on a large industrial scale, preferably on that known as Desmodur® T80 from Bayer A G Leverkusen, D E.

This object was then achieved via the process described in more detail below.

The invention provides a process for preparation of TDI-based isocyanurate polyisocyanate solutions, by trimerizing

A) in a solvent which comprises at least one dialkyl phthalate having branched alkyl radicals,
B) isomer mixtures of tolylene diisocyanate with <35% by weight of 2,6-tolylene diisocyanate
C) in the presence of a catalyst which comprises at least one nitrogen base of Mannich base type, and
D) in rigorous absence of compounds containing aliphatic hydroxy and/or urethane groups
until the content of free non-trimerized residual TDI monomers is ≦0.2% by weight and at the same time the viscosity at 23° C. is <20000 mPas and the solids content, based on the isocyanurate polyisocyanate present is >25% by weight.

The invention also provides the TDI-based isocyanurate polyisocyanate solutions obtainable by the inventive process whose viscosity at 23° C. is <20000 mPas, whose content of free non-trimerized residual TDI monomers is ≦0.2% by weight and whose solids content, based on the isocyanurate polyisocyanate present, is >25% by weight.

Since the progress of the trimerization reaction is affected not only by the catalyst but also by way of example via the solvent used, the isomer constitution of the TDI, or the simultaneous presence of, for example, compounds containing hydroxy groups, it was not to be expected that specifically the inventively significant combination of solvent, catalyst and maximum amount of 2,6-TDI with simultaneous absence of hydroxy compounds would give adhesion promoters with the required properties.

Isomeric diisononyl phthalates are preferably used as branched dialkyl phthalates in component A), and those whose boiling point at 1013 mbar is at least 250° C. and which are liquid at room temperature are particularly preferably used.

Diisononyl phthalate usually means diesters of the Formula (I)

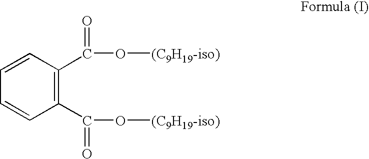

without any more precise definition of its branched alkyl chains.

These diisononyl phthalates (DINP) are commercially available inter alia with the following trademarks: Palatinol® N (BASF, Ludwigshafen D E), Diplast® NS (Lonza, Basel, C H), Jayflex® DINP (phthalates with branched C₈-C₁₀-alkyl groups, with high content of C₉ groups; Exxon-Mobil Chemical Houston, USA) or Vestinol® 9 DINP (Oxeno Olefinchemie GmbH, Marl, D E).

Jayflex® DINP and Vestinol® 9 DINP are preferred diisononyl phthalates, and Vestinol® 9 DINP is particularly preferred.

It is preferable that exclusively phthalates of the abovementioned type are used as solvent in A).

In the component of B), binary mixtures composed of diisocyanatotoluene isomers are typically used. These isomer mixtures preferably comprise 2,4-diisocyanatotoluene mixed with from 5 to 25% by weight of 2,6-diisocyanatotoluene, based on the entire mixture. The TDI isomer mixture particularly preferably comprises 2,4-diisocyanatotoluene mixed with from 15-25% by weight of 2,6-diisocyanatotoluene. In one example, this TDI isomer mixture to be used with particular preference is Desmodur® T80, commercially available from Bayer A G, Leverkusen, D E. The trimerization catalyst C) comprises nitrogen bases of Mannich type (β-amino-carbonyl compounds).

These are preferably those of the type known per se, based on phenols, as obtained in a manner known per se via Mannich Reaction (R. Schröter: Houben-Weyl, Meth. d. org. Chemie [Methods of Organic Chemistry] 11, 1 pp. 756 ff (1957)) of phenols with aldehydes, preferably formaldehyde, and with secondary amines, preferably dimethylamine, and suitable choice of the molar ratios of the starting materials here gives mono- or polynuclear Mannich bases having at least one dialkylaminobenzyl group in the molecule alongside phonetically bonded hydroxy groups. For preparation of the inventively preferred Mannich bases, one to three mol of aldehyde and from one to three mol of secondary amine are generally used per mole of phenol.

Suitable phenols for preparation of the Mannich bases to be used with preference according to the invention are mono- or polyhydric phenols having at least one CH bond capable of condensation with respect to formaldehyde and in o- and/or p-position with respect to the phenolic hydroxy groups. Examples are phenols such as cresols, xylenols, dihydroxybenzenes, nonylphenols, nonylcresols, tert-butylphenols, isodecylphenols, ethylphenols, etc.

The phenols used can also have substitution via substituents such as chlorine or bromine. Instead of these mononuclear phenols, it is also possible to use polynuclear phenols, such as 4,4′-dihydroxydiphenylmethane, tetrachloro- and tetrabromo-4,4′-dihydroxydiphenylmethane, tetrachloro- and tetrabromo-4,4′-dihydroxydiphenylmethane, 4,4′-dihydroxybiphenyl or 2,4-dihydroxydiphenylmethane. As aldehyde, it is preferable to use formaldehyde in the form of an aqueous formalin solution, or as paraformaldehyde or trioxane. Mannich bases prepared using other aldehydes, e.g. butyraldehyde or benzaldehyde, are also suitable for the inventive process. Preferred secondary amine is dimethylamine. However, other secondary aliphatic amines having C₁-C₁₈-alkyl radicals are also suitable for preparation of the Mannich bases to be used according to the invention, examples being N-methylbutylamine, cycloaliphatic secondary amines of the formula HN(R₁)R₂ (R₁═C₁-C₄-alkyl, R₂═C₅-C₇-cycloalkyl), e.g. N-methylcyclohexylamine, or else heterocyclic secondary amines, e.g. piperidine, pyrollidone or morpholine.

Mannich bases based on other C—H-acidic compounds, for example based on indole, are also suitable for the inventive process, but are less preferred.

It is preferable to use exclusively Mannich bases of the abovementioned type as catalysts in C).

The amounts of the trimerization catalysts of component C) used in the inventive process are from 0.001 to 5% by weight, preferably from 0.01 to 3% by weight, based on the entire diisocyanate mixture.

The trimerization of the compounds of component B) is carried out in the presence of the inventively significant solvent component A), but in rigorous absence of aliphatic hydroxy groups and urethane groups.

The trimerization reaction takes place in the temperature range from 40 to 140° C., preferably from 40 to 80° C., the trimerization here being terminated via thermal decomposition of the catalyst, or else preferably via addition of a catalyst poison.

Examples of catalyst poisons suitable for the termination of the trimerization reaction are acids or acid derivatives, e.g. perfluorobutanesulphonic acid, propionic acid, the isomeric phthaloyl chlorides, benzoic acid, benzoyl chloride, or quaternizing agents, e.g. methyl toluenesulphonate. Mono- or diphosphoric esters are also suitable for this purpose.

In one preferred embodiment of the inventive process, the trimerization of the TDI from B) takes place under the abovementioned conditions and uses the components A) and C) described above. The amount used here of the component of B) at this stage corresponds to the desired amount of >25% by weight of TDI-based polyisocyanate for the final product. As an alternative, more TDI is used initially, and the desired solids content is established subsequently via addition of further solvent of component A) during, or after conclusion of, the trimerization reaction.

The conduct of the inventive process in practice is typically that a mixture of the component of B) in the solvent A) is treated at room temperature or, even at this stage, at the intended reaction temperature, with the catalyst, continuously or if appropriate in portions, and the reaction temperature is maintained within the temperature ranges mentioned via the catalyst-addition rate or via external heating or external cooling, until the NCO content of the mixture has fallen to the target value. The reaction is then preferably terminated via addition of a catalyst poison. However, the trimerization reaction here must always be continued until the content of free TDI monomers in the reaction mixture is ≦0.2% by weight.

This method gives TDI-based isocyanurate polyisocyanate solutions whose content of isocyanurate polyisocyanate is more than 25% by weight, preferably from 25 to 50% by weight, particularly preferably from 26 to 35% by weight, and whose viscosity at 23° C. is simultaneously <20000 mPas, preferably <10000 mPas, and whose residual monomer content is preferably from 0.005 to 0.2% by weight.

The inventive solutions are clear, almost colourless liquids which, even after storage for more than a week have no tendency toward crystallization or toward formation of precipitates or phase separation. They also feature extremely low content of free TDI, even after storage, and this is a particular advantage of the inventive solutions, because this toxicologically hazardous diisocyanate has a relatively low boiling point.

DE-A 24 19 016 of the prior art contains neither any data concerning the use of Mannich bases for the trimerization of TDI or of TDI isomer mixtures nor the use of branched dialkyl phthalates, such as in particular the isomeric diisononyl phthalates. The products prepared according to DE-A 24 19 016 moreover have viscosities of 35000 mPas/23° C., at solids contents as low as ≦15% by weight. There is no indication of the suitability of the procedure described for preparation of low-monomer-concentration products with ≦0.2% by weight of free TDI. The Comparative Examples 1-3 which follow demonstrate that the solvents or plasticizers generally described in DE-A 24 19 016 are not at all suitable for provision of the inventively significant properties required here, even with use of Mannich bases and of the TDI isomer mixtures to be used according to the invention.

US-A 4 115 373 describes the TDI trimerization reaction in suitable PVC plasticizers, using exclusively isomerically pure 2,4-diisocyanatotoluene. Adhesion promoters of this type, based purely on 2,4-TDI, are disadvantageous because of compatibility problems of specific adhesion promoter formulations, and the use of isomer mixtures is therefore specifically desired. U.S. Pat. No. 4,115,373 does not say this, however. The trimerization of 2,4- and 2,6-TDI isomer mixtures for preparation of low-monomer-concentration polyisocyanates is moreover not trivial, because the two isomers behave differently with respect to the trimerization reaction, and 2,6-TDI reacts with low selectivity. In addition, the products described in U.S. Pat. No. 4,115,373 have viscosities of 400000 mPas/20° C. at residual monomer content as low as 0.7% by weight, and with this are far removed from the inventively required properties.

Example 17 of DE-A 3 041 732 gives a description of the trimerization of TDI with 35% by weight of the 2,6-isomer in the presence of Mannich bases in dioctyl phthalate. However, even with residual TDI content of more than 0.4% by weight and solids contents of <25% by weight, these products have viscosities of about 9000 mPas/23° C. A further trimerization reaction for lowering of the residual monomer content ≦0.2% by weight would lead to a drastic rise in viscosity, and would thus give products outside the inventively significant specification. That specification can only be achieved via the use of branched-aliphatic dialkyl phthalates, in particular diisononyl phthalate.

The inventive solutions are suitable as adhesion promoters for plasticized PVC and in particular as adhesion-promoting additives for PVC plastisols. The inventive solutions are particularly advantageously used as adhesion promoters between substrates composed of synthetic fibres having groups reactive toward NCO groups, e.g. polyamide or polyester fibres, and PVC plastisols or plasticized PVC melts. The inventive solutions can, of course, also be used to improve the adhesion of plasticized PVC or PVC plastisols on sheet-like substrates, i.e. foils.

The present invention therefore also provides the use of the inventive solutions as adhesion-promoting additives for coating compositions based on plasticized polyvinyl chloride.

An example of a procedure for the inventive use of the inventive solutions applies the inventive solutions to the substrates to be coated by printing, or by doctoring, or in the form of a grid, or by spraying, or by dipping. As a function of the item to be produced, one or more adhesion-promoter-free PVC layers is/are applied, e.g. as plastisols or via extrusion coating or hot melt coating or via lamination, to the resultant pretreated substrate surfaces. The inventive solutions can also particularly preferably be added to a PVC plastisol prior to its application.

The amounts used of the inventive solutions are normally such that, based on plasticizer-free polyvinyl chloride in the coating composition, the amount of isocyanurate polyisocyanate present is from 0.5 to 2000% by weight, preferably from 2 to 30% by weight. However, the amounts used of the inventive solutions can also be any other desired amounts appropriate to the respective application sector.

The production of the finished layers, i.e. the reaction of the NCO groups of the adhesion promoter with the substrate and the gelling of the PVC layer, takes place in the usual way at relatively high temperatures irrespective of the application method, usual temperatures being from 130 to 210° C., as a function of the constitution of the PVC layers.

The inventive solutions are suitable as adhesion-promoting additives for coatings based on plasticized PVC, in particular for production of tarpaulins, of air-supported membranes in halls and of other textile buildings, of flexible containers, of polygonal roofs, of awnings, of protective clothing, of conveyor belts, of flock carpets or of foamed synthetic leather. The inventive solutions have particularly good suitability as adhesion-promoting additives in the coating of substrates having groups reactive toward isocyanate groups, in particular in the coating of substrates based on synthetic fibres having groups reactive toward isocyanate groups.

### EXAMPLES

Unless otherwise stated, all percentages are based on percent by weight. Isocyanate content was determined using the specifications of EN ISO 11909.

Properties determined for the products were the solids content (thick-layer method: Cap, 1 g of specimen, 1 h 125° C. convection oven, based on DIN EN ISO 3251), viscosity (at 23° C., VT550 rotary viscometer from Haake GmbH, Karlsruhe, D E), and residual TDI monomer content (gas chromatography, Hewlett Packard 5890 to DIN ISO 55956).

Starting materials used were:
Desmodur® T80: TDI isomer mixture composed of 80% by weight of 2,4-TDI and 20% by weight of 2,6-TDI, Bayer A G, Leverkusen, D E
Desmodur® T65: TDI isomer mixture composed of 65% by weight of 2,4-TDI and 35% by weight of 2,6-TDI, Bayer A G, Leverkusen, D E
Adimoll® DO: di(2-ethylhexyl) adipate, Bayer A G, Leverkusen, D E
Jayflex® DINP: diisononyl phthalate, Exxon-Mobil Chemical, Houston, Tex., US
Vestinol® 9 DINP: diisononyl phthalate, Oxeno Olefinchemie GmbH, Marl, D E

### Catalyst I:

### Preparation According to DE-A 2 452 531

188 parts by weight of bisphenol A were heated for two hours at 80° C. with 720 parts of a 25% strength aqueous dimethylamine solution and with 425 parts by weight of a 40% strength formaldehyde solution. After cooling, the organic phase was separated and worked up by distillation at 90° C./10 torr, giving the desired Mannich base.

### Comparative Example 1

### Corresponding to DE-A 30 417 32, Example 17

130 g of Desmodur® T65 were trimerized at 50° C. in 390 g of dioctyl phthalate (DOP) with a total of 2.2 ml of a catalyst based on a Mannich base derived from isononylphenol, formaldehyde and dimethylamine, corresponding to Example 2 of U.S. Pat. No. 4,115,373. After a total of 370 minutes, the reaction was interrupted via addition of 1 ml of a solution of 1 ml of perfluorobutanesulphonic acid in 2 ml of dimethylformamide. This gave a clear solution with 24.7% solids, 3.8% NCO content, viscosity of 12000 mPas (23° C.) and residual free TDI monomer content of 0.41%.

This example shows that the inventively significant property profile could not be achieved on the basis of TDI isomer mixtures with ≧35% by weight of 2,6-TDI. Although a prolonged reaction time here would lead to further TDI conversion (and with this lower residual monomer content), viscosities outside the claimed range would then be obtained.

### Comparative Example 2

180 g of Desmodur® T80 were trimerized at 45° C. in 414 g of Adimoll® DO with a total of 2.2 ml of the catalyst I (30% strength solution in butyl acetate/xylene 50:50 vol:vol). After a total of 300 minutes, the reaction was interrupted via addition of a stopper, because marked clouding occurred and the product obtained was therefore not homogeneous.

### Comparative Example 3

180 g of Desmodur® T80 were trimerized at 45° C. in 414 g of Benzoflex® 2088 with a total of 1.8 g of a catalyst I (30% strength solution in butyl acetate/xylene 50:50 vol:vol). After a total of 84 hours, the reaction was interrupted via addition of 1.65 g of methyl para-toluenesulphonate, and stirring was continued for one hour at from 60 to 70° C. This gave a clear solution whose NCO content was 4.8%, whose viscosity was >200000 mPas (23° C.) and whose residual free TDI monomer content was 1.09%.

As Comparative Examples 2 and 3 show, the choice of the solvent has a decisive effect on the result of the trimerization reaction. For example, the desired property combination cannot be achieved via use of the plasticizers or solvents described in the prior art, e.g. di(2-ethylhexyl) adipate or ethylene glycol dibenzoate.

### INVENTIVE EXAMPLES

### Example 1

180 g of Desmodur® T80 were trimerized at 45° C. in 489 g of Jayflex® DINP with a total of 7.85 g of a catalyst I (30% strength solution in butyl acetate/xylene 50:50 vol:vol). After a total of 84 hours, the reaction was interrupted via addition of 4.65 g of methyl para-toluenesulphonate, and stirring was continued for one hour at from 60 to 70° C. Solids content was adjusted to 27% via addition of 13.4 g of DINP. This gave a clear solution whose NCO content was 4.7%, whose viscosity was 5700 mPas (23° C.) and whose residual free TDI monomer content was 0.16%.

### Example 2

1567 g of Desmodur® T80 were trimerized at 45° C. in 3932.5 g of Vestinol® 9 DINP with a total of 60.29 g of a catalyst I (30% strength solution in butyl acetate/xylene 50:50 vol:vol). After a total of 84 hours, the reaction was interrupted via addition of 29.95 g of methyl para-toluenesulphonate, and stirring was continued for one hour at from 60 to 70° C. Solids content was adjusted to 28.5% via addition of 107.3 g of DINP. This gave a clear solution whose NCO content was 5.1%, whose viscosity was 6100 mPas (23° C.) and whose residual free TDI monomer content was 0.17%.

### Example 3

180 g of Desmodur® T80 were trimerized at 45° C. in 414.6 g of Jayflex® DINP with a total of 4.8 g of a catalyst I (30% strength solution in butyl acetate/xylene 50:50 vol:vol). After a total of 48 hours, the reaction was interrupted via addition of 6.11 g of methyl para-toluenesulphonate, and stirring was continued for one hour at from 60 to 70° C. This gave a clear solution whose solids content was 30%, whose NCO content was 5.61%, whose viscosity was 7900 mPas (23° C.) and whose residual free TDI monomer content was 0.14%.

### Example 4

285 g of Desmodur® T80 were trimerized at 75° C. in 715 g of Vestinol® 9 DINP with a total of 7.96 g of a catalyst I (30% strength solution in butyl acetate/xylene 50:50 vol:vol). After a total of 56 hours, the reaction was interrupted via addition of 3.98 g of methyl para-toluenesulphonate, and stirring was continued for one hour at from 60 to 70° C. This gave a clear solution whose solids content was 28.5%, whose NCO content was 4.8%, whose viscosity was 10000 mPas (23° C.) and whose residual free TDI monomer content was 0.15%.

### Performance Testing and Test Results:

In a test system similar to industrial systems, polyamide textile or polyester textile was provided with a PVC plastisouadhesion promoter coating. The adhesion of this coating was then determined on a standardized test strip. For this, a doctor was used to provide textile (polyester or polyamide) with a tie coat comprising adhesion promoter and with two adhesion-promoter-free outer coats having otherwise the same composition. These coatings were fully gelled in a heating cabinet and then tested. When testing adhesion, a few centimetres of the coating were peeled away from the textile so that coating and textile could be clamped into the tensile test machine, and the two layers were then further separated.

The intention here was therefore that the first centimetres of the coating be easy to separate manually. This was achieved via anti-adhesive impregnation of a width of about 5 cm, applied in a thin layer to one end of the textile by a hand-operated doctor.

### Constitution of Anti-adhesive Impregnation Material

| Constituents | Amount | |
|---|---|---|
| Cellit ® 900, Bayer AG, Leverkusen, DE | 105 | parts by weight |
| Ethyl acetate | 595 | parts by weight |
| Alkylsulphonate | 10 | parts by weight |

The material was applied to one side, on that side of the textile on which the tie coat was also subsequently applied. Prior to further processing, the anti-adhesive impregnation material was dried in a fume cupboard.

### Test Equipment

balance, min. precision 0.1 g
stirrer: high-rotation-rate bar stirrer
heating cabinets with air circulation, T=140° C. and 175° C.
manually operated doctor, width 150 mm
knife-over-rubber-blanket coater, width about 45 cm, with sharp-edged knife
knife-over-rubber-blanket coater, width about 45 cm, with blunt-edged knife
plain-woven polyester, 1100 dtex, 1/1 construction, sett: 9/9 ends/picks per cm
plain-woven nylon-6,6, 940 dtex, 1/1 construction, sett: 8.5-9.5 ends/picks per cm

Textile specimens of dimensions about 40×25 cm were used for testing.

### Preparation of Pvc Plastisol

| Constituents | Amount | |
|---|---|---|
| Vestolit ® B 021 ⁽¹⁾ | 30 | parts by weight |
| Vestolit ® E 8001 ⁽²⁾ | 30 | parts by weight |
| Mesamoll ® ⁽³⁾ | 20 | parts by weight |
| Vestinol ® AH ⁽⁴⁾ | 20 | parts by weight |
| Omyalite ® 95T ⁽⁵⁾ | 6 | parts by weight |
| Naftovin ® T90 ⁽⁶⁾ | 2 | parts by weight |
| Bayplast ® Green 8 GN ⁽⁷⁾ | 0.2 | part by weight |

^{(1), (2)} paste PVC from Vestolit GmbH, Marl, DE
⁽³⁾ plasticizer from Bayer AG, Leverkusen, DE
⁽⁴⁾ plasticizer from Oxeno Olefinchemie GmbH, Marl, DE
⁽⁵⁾ calcium carbonate from Omya Australia, Sydney, AU
⁽⁶⁾ stabilizer, Chemson GmbH, Frankfurt, DE
⁽⁷⁾ organic colour pigment, Bayer AG, Leverkusen, DE

The plastisol was prepared in a mixer from Drais, Mannheim, D E via stirring (2.5 h) at maximum rotation rate and water-cooling in vacuo.

### Tie Coat

The tie coat based on the above plastisol with varying adhesion-promoter contents was applied, using a rubber blanket and sharp-edged knife, to the respective polyester textile and polyamide textile (Lüickenhaus, D E, plain-woven polyester, 1100 dtex, 1/1 construction, sett: 9/9 ends/picks per cm or plain-woven nylon-6,6, 940 dtex, 1/1 construction, sett: 8.5-9.5 ends/picks per cm). The application weight here was about 100 g/m², and the area coated in each case was about 30×20 cm. The tie coats were then pregelled via exposure to 140° C. for 2 minutes in a heating cabinet with air circulation, before the outer coats were applied.

### First Outer Coat

The first outer coat based on the above plastisol was applied using a rubber blanket and blunt-edged knife (application weight about 850 g/m²) and pregelled via annealing at 140° C. in a heating cabinet for 1 minute.

### Coating on Reverse Side of Textile

The reverse side of the textiles was then given an outer coat which inhibited tearing and fraying of the textiles during separation of the layers via the tensile testing machine. The coating on the reverse side of the textile was applied using a rubber blanket with blunt-edged knife (application weight about 150 g/m²) and pregelled via annealing at 140° C. in a heating cabinet for 1 minute.

### Second Outer Coat

The second outer coat, also based on the PVC plastisol described above, was applied using a rubber blanket and blunt-edged knife (application weight about 1400 g/m²) to the first pregelled outer coat and pregelled via annealing at 140° C. in a heating cabinet for 2 minutes.

All of the layers applied were then gelled completely via exposure to 175° C. for 12 minutes.

Test specimens of dimensions 5×26 cm were stamped out from the resultant textile samples. These specimens were then used to determine the adhesion values by means of a Lloyd M 5 K tensile testing machine. The values obtained give the force in newtons needed to peel 5 cm of the coating from the backing textile (peel test). The values given were obtained via averaging of at least three individual measurements.

| Adhesion promoter from | Polyester textile | Polyamide textile |
|---|---|---|
| Example 1 (2% in tie coat) | 170 N/5 cm | 191 N/5 cm |
| Example 1 (4% in tie coat) | 181 N/5 cm | 226 N/5 cm |
| Example 1 (6% in tie coat) | 212 N/5 cm | 225 N/5 cm |
| Example 2 (2% in tie coat) | 176 N/5 cm | 194 N/5 cm |
| Example 2 (4% in tie coat) | 230 N/5 cm | 252 N/5 cm |
| Example 2 (6% in tie coat) | 215 N/5 cm | 253 N/5 cm |
| Example 3 (4% in tie coat) | 206 N/5 cm | 230 N/5 cm |

As shown by the test results, the use of as little as 2% of adhesion promoter in the PVC plastisol as tie coat gives good peel strength values. The adhesion promoters from the Comparative Examples 1-3 were unsuitable for further processing because these either had excessive residual monomer contents for a prescribed solids level and viscosity (Comparative Example 1), or were cloudy (Comparative Example 2) or were too viscous (Comparative Example 3) to be capable of giving homogeneous coatings.

1. Process for preparation of tolylene-diisocyanate-based isocyanurate polyisocyanate solutions, by trimerizing
A) in a solvent which comprises at least one dialkyl phthalate having branched alkyl radicals,
B) isomer mixtures of tolylene diisocyanate with <35% by weight of 2,6-tolylene diisocyanate
C) in the presence of a catalyst which comprises at least one nitrogen base of Mannich base type,
D) and in rigorous absence of compounds containing aliphatic hydroxy and/or urethane groups
until the content of free non-trimerized residual TDI monomers is <0.2% by weight and at the same time the viscosity at 23° C. is <20000 mPas and the solids content, based on the isocyanurate polyisocyanate present is >25% by weight.

2. Process for preparation of tolylene-diisocyanate-based isocyanurate polyisocyanate solutions, characterized in that exclusively the isomeric diisononyl phthalates are used as solvent in A).

3. Process for preparation of tolylene-diisocyanate-based isocyanurate polyisocyanate solutions, characterized in that the 2,6-TDI content of the tolylene diisocyanate mixtures used in component B) is from 15 to 25% by weight.

4. Tolylene-diisocyanate-based isocyanurate polyisocyanate solutions obtainable by the process according to any of claims 1 to 3.

5. Use of the tolylene-diisocyanate-based isocyanurate polyisocyanate solutions according to claim 4 as adhesion-promoting additives for polyvinyl chloride.

6. Coatings obtainable using the tolylene-diisocyanate-based isocyanurate polyisocyanate solutions according to claim 4.

7. Substrates coated with coatings according to claim 6.
